(19) United States
(12) Patent Application Publication
(10) Pub. No.: US 2026/0168633 A1
(43) Pub. Date: Jun. 18, 2026

(54) INDOOR LIGHTING FIXTURE

(71) Applicant: DONGWOO FINE-CHEM CO., LTD., Iksan-si (KR)

(72) Inventor: Do-Kyu LEE, Iksan-si (KR)

(73) Assignee: DONGWOO FINE-CHEM CO., LTD., Iksan-si (KR)

(21) Appl. No.: 19/126,460

(22) PCT Filed: Oct. 26, 2023
(86) PCT No.: PCT/KR2023/016725

§ 371 Date: May 1, 2025

(30) Foreign Application Priority Data
Nov. 1, 2022 (KR) 20-2022-0002558

(51) Int. Cl. F21S 9/03; F21Y 115/10

(52) U.S. Cl. CPC F21S 9/03; F21Y 2115/10

(57) ABSTRACT

Disclosed herein is an indoor lighting fixture that includes an LED light, and a drive device connected to the LED light to drive the LED light, wherein the drive device includes a solar cell on at least a portion of its outside to generate electrical energy by absorbing visible light emitted from the LED light, and the drive device further includes therein a rechargeable battery charged with the generated electrical energy.

### TECHNICAL FIELD

The present disclosure relates to an indoor lighting fixture.

### BACKGROUND ART

Zero-Energy Building (ZEB) refers to a building constructed to have increased energy performance so that users are able to live without additional energy supply from outside. Passive and/or active technologies, etc. may be utilized to construct zero-energy buildings. The passive technology is a technology that uses high-performance insulating materials, high-airtightness windows, etc. to minimize a loss in energy, while the active technology is a technology that uses high-efficiency devices and renewable energy.

As an example of the active technology for constructing zero-energy buildings, the use of low-power building materials may be considered. In other words, the zero-energy buildings may be constructed by minimizing the power consumption of lighting fixtures that consume a lot of power in buildings, and the use of solar panels is being discussed as a way to reduce the power consumption of the lighting fixtures.

Korean Patent No. 10-1658426 discloses a portable LED lamp using solar energy. However, this is problematic in that it is inefficient when used in indoor lighting fixtures since outdoor light, sunlight, is essential to charge solar panels.

### DISCLOSURE

### Technical Problem

The present disclosure has been made in view of the above-mentioned problem, and an object of the present disclosure is to provide an indoor lighting fixture having excellent indoor light conversion efficiency.

### Technical Solution

In accordance with an aspect of the present disclosure, there is provided an indoor lighting fixture that includes an LED light, and a drive device connected to the LED light to drive the LED light, wherein the drive device includes a solar cell on at least a portion of its outside to generate electrical energy by absorbing visible light emitted from the LED light, and the drive device further includes therein a rechargeable battery charged with the generated electrical energy.

The visible light absorbed by the solar cell may have a wavelength of 300 nm to 800 nm.

The visible light absorbed by the solar cell may have a wavelength of 380 nm to 800 nm.

The solar cell may include at least one selected from a Si-based photovoltaic cell, an inorganic thin-film-based photovoltaic cell of group III-V, group II-VI, and group I-III-VI, an organic photovoltaic cell, and a dye-sensitized photovoltaic cell.

The solar cell may be an organic photovoltaic cell.

The electrical energy generated by the solar cell may be utilized as auxiliary power for the indoor lighting fixture.

The drive device may further include therein a power inverter configured to convert the electrical energy stored in the rechargeable battery into energy that is usable by the LED light.

The drive device may further include an input module configured to receive external power, and the power input from the input module may be used to charge the rechargeable battery.

The input module may receive external power if the electrical energy charged in the rechargeable battery is discharged to a threshold value or less.

The drive device may further include therein an LED inverter configured to drive the LED light.

The indoor lighting fixture may include a plurality of LED lights and a plurality of drive devices, which are connected to each other.

### Advantageous Effects

An indoor lighting fixture including a solar cell according to the present disclosure can have reduced power consumption due to high light conversion efficiency.

### BRIEF DESCRIPTION OF DRAWINGS

FIG. 1 is a view illustrating an indoor lighting fixture according to an embodiment of the present disclosure.

FIG. 2 is a graph illustrating a light source intensity by wavelength and a solar-cell power conversion efficiency.

FIG. 3 is a view illustrating an indoor lighting fixture according to another embodiment of the present disclosure.

FIG. 4 is a view illustrating an indoor lighting fixture according to still another embodiment of the present disclosure.

FIGS. 5A and 5B are perspective views illustrating an implementation of an indoor lighting fixture according to yet another embodiment of the present disclosure.

FIG. 6 is a perspective view illustrating an inside of a drive device of an indoor lighting fixture according to still yet another embodiment of the present disclosure.

FIG. 7 illustrates an example of an organic photovoltaic cell module.

FIG. 8 is a view illustrating an implementation of an indoor lighting fixture according to a further embodiment of the present disclosure.

### LIST OF REFERENCE NUMERALS

100: indoor lighting fixture
110: LED light
112: first light-emitting region
114: second light-emitting region
120: drive device
122: solar cell
123: electrode layer
1231: reflected light
124: rechargeable battery
125: input module
126: power inverter
128: LED inverter
200: light source intensity by wavelength
202: outdoor light
204: LED bulb
206: compact fluorescent bulb (CFL)
208: incandescent bulb
210: power conversion efficiency
212 and 214: first and second Si-based photovoltaic cell efficiencies
216 and 218: first and second organic photovoltaic cell efficiencies
700: organic photovoltaic cell module

### BEST MODE

The present disclosure relates to a high-efficiency indoor lighting fixture using a solar cell with high light conversion efficiency.

The present disclosure will be described in detail below.

Throughout this specification, it will be understood that, when an element is referred to as being located or included “outside/inside” or “at a part of” another element, this encompasses not only when an element is in contact with another element, but also when any element exists between the two elements.

Throughout this specification, it will be understood that, when a component is referred to as “comprising” or “including” any component, it does not exclude other components, but can further comprise or include the other components unless otherwise specified.

Hereinafter, in order to specifically describe the present disclosure, exemplary embodiments thereof will be given in detail. However, the embodiments of the present disclosure may be embodied in different forms and the present disclosure should not be construed as being limited to the embodiments set forth herein. Rather, these embodiments are provided so that the present disclosure will be thorough and complete, and will fully convey the scope of the present disclosure to those skilled in the art.

### MODE FOR DISCLOSURE

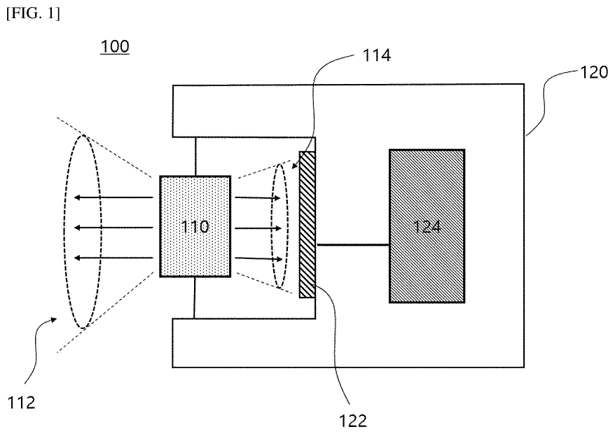

FIG. 1 is a view illustrating an indoor lighting fixture 100 according to an embodiment of the present disclosure. FIG. 1 illustrates only necessary parts of the indoor lighting fixture 100 in the present disclosure, and the indoor lighting fixture 100 may include additional parts besides those illustrated in FIG. 1.

Referring to FIG. 1, the indoor lighting fixture 100 may include an LED light 110 and a drive device 120, and the drive device 120 may include a solar cell 122 and a rechargeable battery 124. The drive device 120 is illustrated as including only the solar cell 122 and the rechargeable battery 124 in FIG. 1, but this is merely for convenience of explanation and the drive device 120 may further include a control unit (not shown), an LED inverter 128 (see FIG. 4), etc. for driving the indoor lighting fixture 100 according to this embodiment.

The LED light 110 is a lighting unit using light-emitting diodes, and the drive device 120 may be connected to the LED light 110 to drive the LED light 110.

The drive device 120 according to this embodiment includes the solar cell 122 on at least a portion of the outside thereof to generate electrical energy by absorbing the visible light emitted from the LED light 110, and includes therein the rechargeable battery 124 that is charged with the electrical energy generated by the solar cell 122.

For example, the LED light 110 may emit light toward a first light-emitting region 112 and a second light-emitting region 114. In this case, the first light-emitting region 112 may be outside the indoor lighting fixture 100, and the second light-emitting region 114 may be inside the indoor lighting fixture 100, but the present disclosure is not limited thereto.

The light emitted toward the first light-emitting region 112 may be used to illuminate the outside of the indoor lighting fixture 100, and the light emitted toward the second light-emitting region 114 may be used to charge the rechargeable battery 124 through the solar cell 122. The electrical energy charged in the rechargeable battery 124 may be appropriately converted through an inverter (not shown) and then used to drive the LED light 110. As such, the electrical energy generated by the solar cell 122 according to this embodiment may be utilized as auxiliary power for the indoor lighting fixture 100, but the present disclosure is not limited thereto. For example, the above electrical energy may also be utilized as main power.

The solar cell 122 according to this embodiment may absorb visible light of the spectrum of light emitted toward the second light-emitting region 114. In this case, the visible light absorbed by the solar cell 122 may have a wavelength of, but not limited to, 300 nm to 800 nm, preferably 380 nm to 800 nm, and more preferably 400 nm to 700 nm.

In addition, the solar cell 122 according to this embodiment may include, but not limited to, at least one selected from a Si-based photovoltaic cell, an inorganic thin-film-based photovoltaic cell of group III-V, group II-VI, and group I-III-VI, an organic photovoltaic (OPV) cell, and a dye-sensitized photovoltaic cell. Furthermore, the solar cell 122 may include any cell that generates electrical energy using light. Examples of the group III-V inorganic thin-film-based photovoltaic cell include GaAs, InP, GaInAs, GaAlAs, etc., examples of the group II-VI inorganic thin-film-based photovoltaic cell include CdTe, CdS, ZnS, etc., and examples of the group I-III-VI inorganic thin-film-based photovoltaic cell include CIS/Se, CGS/Se, CIGS, etc. The solar cell 122 of the indoor lighting fixture 100 according to this embodiment may be implemented as an organic photovoltaic cell to increase light conversion efficiency in indoor lighting, but the present disclosure is not limited thereto.

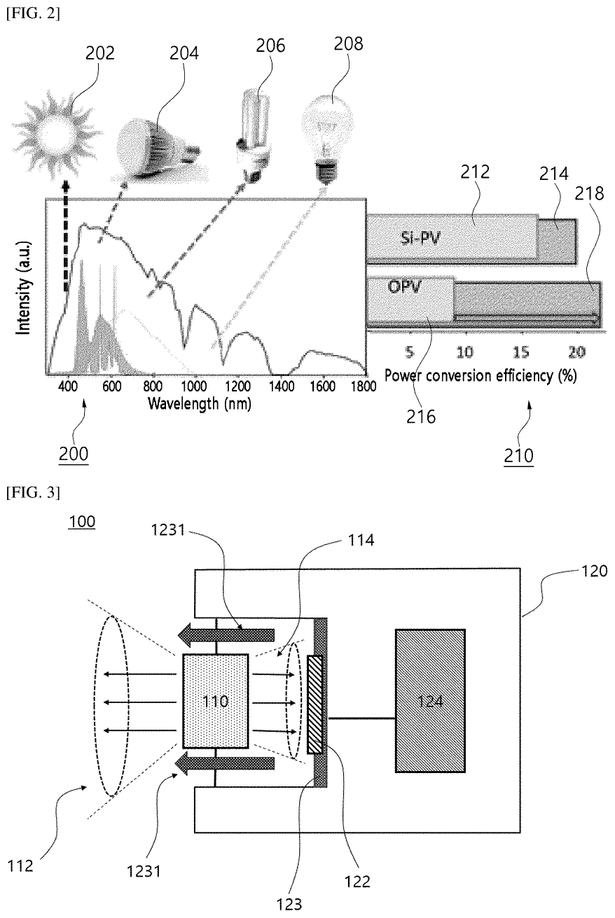

In the following, the wavelength absorbed by the solar cell 122 and the light conversion efficiency will be described in more detail with reference to FIG. 2.

FIG. 2 is a graph illustrating a light source intensity by wavelength and a solar-cell power conversion efficiency (Hwa Sook Ryu et al. (2020), Recent progress in indoor organic photovoltaics, [symbol] issue 10, 5792-5804; etc.). Referring to FIG. 2, a graph for a light source intensity by wavelength 200 and a chart for a solar-cell power conversion efficiency 210 are illustrated.

The light source intensity by wavelength 200 illustrated in FIG. 2 represents an intensity by wavelength for each of outdoor light 202, an LED bulb 204, a compact fluorescent bulb (CFL) 206, and an incandescent bulb 208. The LED light 110 according to this embodiment may use an LED bulb 204, and the LED bulb 204 has a predetermined value of intensity in a wavelength band of 300 nm to 800 nm, and in particular, a high value of intensity in a wavelength band of 380 nm to 770 nm. Accordingly, the visible light absorbed by the solar cell 122 according to this embodiment may have a wavelength of, but not limited to, 300 nm to 800 nm, and preferably 380 nm to 800 nm.

In addition, the solar-cell power conversion efficiency 210 illustrated in FIG. 2 represents first and second Si-based photovoltaic cell efficiencies 212 and 214 and first and second organic photovoltaic cell efficiencies 216 and 218. In this case, the first Si-based photovoltaic cell efficiency 212 and the first organic photovoltaic cell efficiency 216 refer to efficiencies when outdoor light 202 is used as a light source, and the second Si-based photovoltaic cell efficiency 214 and the second organic photovoltaic cell efficiency 218 refer to efficiencies when indoor light is used as a light source. For example, the indoor light may use the LED bulb 204, the CFL 206, and/or the incandescent bulb 208 as light sources, but the present disclosure is not limited thereto. It can be seen from the illustrated power conversion efficiency 210 that if the indoor light is used as a light source, the second organic photovoltaic cell efficiency 218 is higher than the second Si-based photovoltaic cell efficiency 214. Therefore, the solar cell 122 of the indoor lighting fixture 100 according to this embodiment may be implemented as an organic photovoltaic cell to increase light conversion efficiency in indoor lighting, but the present disclosure is not limited thereto. In this way, as the organic photovoltaic cell is used for the solar cell 122 of the indoor lighting fixture 100, it is possible to realize a light conversion efficiency of 25% or more and thus to implement the indoor lighting fixture 100 with high efficiency. For example, if the indoor lighting fixture 100 according to this embodiment uses an LED light 110 (see FIG. 1) of 1,000 lux or less, the power conversion efficiency of the solar cell 122 may be 25% or more.

Referring again to FIG. 1, the rechargeable battery 124 is charged with the electrical energy generated by the solar cell 122. In other words, the solar cell 122 generates current by absorbing visible light of the spectrum of light emitted from the LED light 110 of the indoor lighting fixture 100, and the current generated by the solar cell 122 is stored in the rechargeable battery 124 in the form of direct current power. At this time, the stored power may be converted by the inverter for use to drive the LED light 110.

The indoor lighting fixture 100 according to this embodiment can ensure high efficiency since the electrical energy generated using the light emitted from the LED light 110 is stored in the rechargeable battery 124 and used to drive the LED light 110.

FIG. 3 is a view illustrating an indoor lighting fixture 100 according to another embodiment of the present disclosure. Since the indoor lighting fixture 100 illustrated in FIG. 3 is identical to the indoor lighting fixture 100 illustrated in FIG. 1, with the sole exception of addition of an electrode layer 123, a redundant description thereof will be omitted.

Typically, a reflector may be provided to reflect the light emitted from lighting. On the other hand, referring to FIG. 3, in the indoor lighting fixture 100 according to the present disclosure, the solar cell 122 may be directly attached to the outside of the drive device 120, the remaining portion of the outside of the drive device 120 to which the solar cell 122 is not attached may have a silver color due to the electrode layer 123 thereon, and the electrode layer may be utilized as a reflector with provision of no separate reflector. The electrode layer 123 according to this embodiment may be made of, but not limited to, a silver (Ag) type material, and may be implemented in various forms that have excellent conductivity while being capable of reflecting the light emitted from the LED light 110.

In addition, the solar cell 122 according to this embodiment may be directly attached to the outside of the electrode layer 123 and/or the drive device 120. Accordingly, the indoor lighting fixture 100 according to this embodiment can have a further increased value of brightness without increasing power consumption by causing multiple types of reflected light 1231 reflected from the electrode layer 123 to be emitted to the outside of the indoor lighting fixture 100.

FIG. 4 is a view illustrating an indoor lighting fixture 100 according to still another embodiment of the present disclosure. Since the indoor lighting fixture 100 illustrated in FIG. 4 is identical to the indoor lighting fixture 100 illustrated in FIG. 1, with the sole exception of addition of an input module 125, a power inverter 126, and an LED inverter 128, a redundant description thereof will be omitted. In addition, although FIG. 4 does not illustrate the electrode layer 123 of FIG. 3, an electrode layer 123 may be added at the same position as illustrated in FIG. 3.

Referring to FIG. 4, the drive device 120 of the indoor lighting fixture 100 may include a solar cell 122, a rechargeable battery 124, an input module 125, a power inverter 126, and/or an LED inverter 128.

The input module 125 receives external power. For example, the input module 125 may include an input unit for receiving additional power from an external power source other than power generated by the solar cell, and a control unit for controlling the input unit.

The power input through the input module 125 according to this embodiment is used to charge the rechargeable battery 124. In this case, the input module 125 according to this embodiment may be implemented to receive external power if the electrical energy charged in the rechargeable battery 124 is discharged to a threshold value or less, but the present disclosure is not limited thereto. For example, the input module 125 may receive constant power for the stable use of the indoor lighting fixture 100. The threshold value in this embodiment may be 10%, but is not limited thereto. Furthermore, the threshold value may be appropriately adjusted for the stable actuation of or depending on the example of use of the indoor lighting fixture 100.

Accordingly, it is possible to enhance the efficiency of the indoor lighting fixture 100 according to this embodiment by appropriately combining and using the electrical energy generated by the solar cell 122 and the electrical energy input from the external power source through the input module 125. At least one of the electrical energy from the solar cell 122 and the electrical energy from the external power source may be utilized as main power, and the electrical energy utilized as main power may be appropriately adjusted depending on the environment of use of the indoor lighting fixture 100. For example, if the solar cell 122 is used as an auxiliary power source, when the solar cell according to the embodiment of the present disclosure is applied to the LED light requiring 100 mW of power, it may provide 10 to 40% of the required power, i.e., 10 to 40 mW of power. Moreover, from the viewpoint of stability, it is preferable for the solar cell to provide 10 to 20% of the required power, i.e., 10 to 20 mW of power.

The power inverter 126 converts the electrical energy stored in the rechargeable battery into energy that is usable by the LED light 110, and the LED inverter 128 drives the LED light 110. In other words, the power inverter 126 converts the direct current power stored in the rechargeable battery 124 into alternating current power to be used for driving the LED light 110, and the LED inverter 128 uses the power produced by the power inverter 126 to drive the LED light 110. The power inverter 126 according to this embodiment may also be used to convert both the electrical energy generated from the solar cell 122 and the electrical energy generated from the external power source through the input module 125.

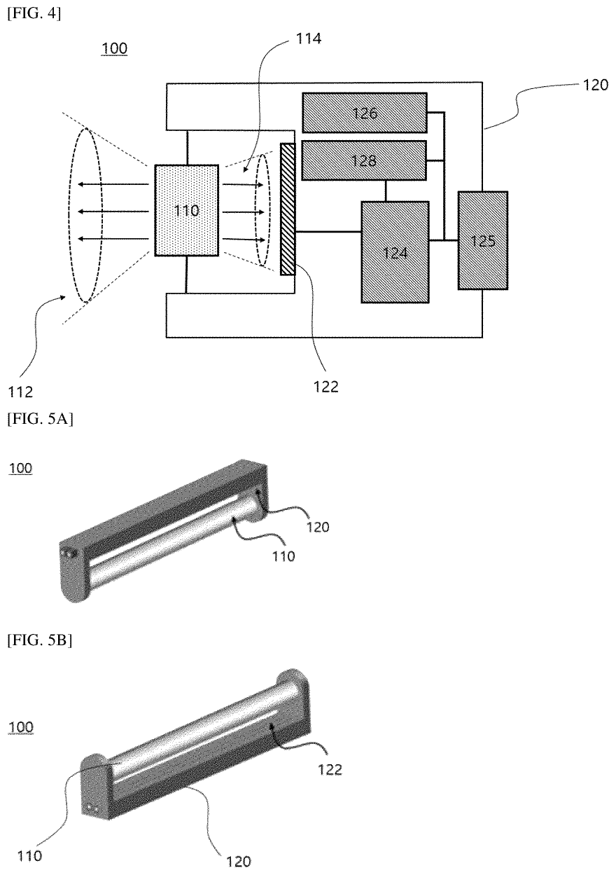

FIGS. 5A and 5B are perspective views illustrating an implementation of an indoor lighting fixture 100 according to yet another embodiment of the present disclosure. Since the indoor lighting fixture 100 illustrated in FIGS. 5A and 5B is identical to the indoor lighting fixtures 100 described with reference to FIGS. 1 to 4, a redundant description thereof will be omitted. In addition, FIGS. 5A and 5B illustrate an exemplary form of the indoor lighting fixture 100 according to this embodiment, and the indoor lighting fixture 100 according to this embodiment may be implemented in various forms without limitation.

FIG. 5A is a forward perspective view of the indoor lighting fixture 100, and FIG. 5B is a reverse perspective view of the indoor lighting fixture 100. Here, the forward direction refers to a direction in which the indoor lighting fixture 100 is installed, but the present disclosure is not limited thereto.

Referring to FIGS. 5A and 5B, the indoor lighting fixture 100 may include an LED light 110 and a drive device 120, and the drive device 120 may include a solar cell 122 on at least a portion of the outside thereof.

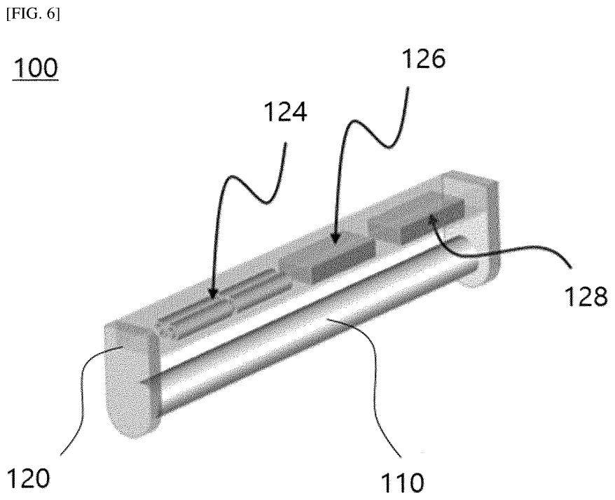

FIG. 6 is a perspective view illustrating an inside of a drive device 120 of an indoor lighting fixture 100 according to still yet another embodiment of the present disclosure. Since the indoor lighting fixture 100 illustrated in FIG. 6 is identical to the indoor lighting fixtures 100 described with reference to FIGS. 1 to 5B, a redundant description thereof will be omitted. Specifically, FIG. 6 is a perspective view illustrating the inside of the drive device 120 relative to the forward perspective view of FIG. 5A. FIG. 6 is an internal perspective view illustrating an example of the indoor lighting fixture 100 in the direction in which it is viewed. Although not shown in FIG. 6, the indoor lighting fixture 100 may further include a solar cell 122 and an input module 125.

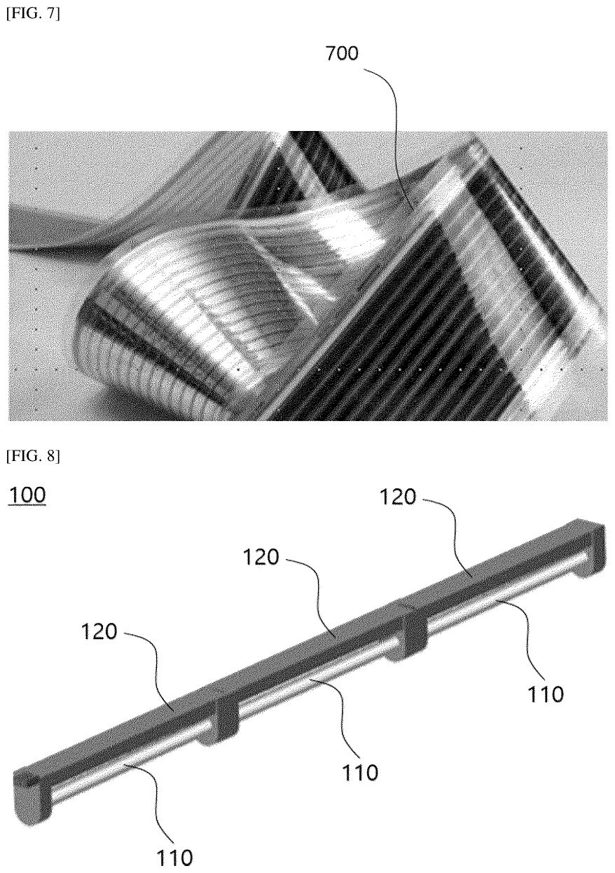

FIG. 7 is a view illustrating an example of an organic photovoltaic cell module 700. The organic photovoltaic cell module 700 illustrated in FIG. 7 may be used as a solar cell 122 according to this embodiment. In other words, the organic photovoltaic cell module 700 may have a back of the absorption surface thereof attached to the outside of the drive device 120 or the electrode layer 123 so that the absorption surface of the organic photovoltaic cell module 700 may absorb the light emitted from the LED light 110.

FIG. 8 is a view illustrating an indoor lighting fixture 100 according to a further embodiment of the present disclosure. The indoor lighting fixture 100 illustrated in FIG. 8 is implemented by combining a plurality of indoor lighting fixtures 100 described with reference to FIGS. 1 to 7. Thus, since the operation of each of LED lights 110 and drive devices 120 illustrated in FIG. 8 is identical to that described with reference to FIGS. 1 to 7, a redundant description thereof will be omitted. As illustrated in FIG. 8, the indoor lighting fixture 100 according to this embodiment may be implemented in a form in which a plurality of LED lights 110 and a plurality of drive devices 120 are connected to each other, respectively.

Accordingly, the indoor lighting fixture 100 according to this embodiment uses the solar cells 122 attached to the respective drive devices 120 to provide a method of driving a plurality of LED lights 110 using light emitted from the LED lights 110. Therefore, it is possible to provide an indoor lighting fixture 100 with excellent indoor light conversion efficiency.

### INDUSTRIAL APPLICABILITY

An indoor lighting fixture including a solar cell according to the present disclosure can have reduced power consumption due to high light conversion efficiency.

1. An indoor lighting fixture comprising:
an LED light; and
a drive device connected to the LED light to drive the LED light, wherein:
the drive device comprises a solar cell on at least a portion of its outside to generate electrical energy by absorbing visible light emitted from the LED light; and
the drive device further comprises therein a rechargeable battery charged with the generated electrical energy.

2. The indoor lighting fixture according to claim 1, wherein the visible light absorbed by the solar cell has a wavelength of 300 nm to 800 nm.

3. The indoor lighting fixture according to claim 1, wherein the visible light absorbed by the solar cell has a wavelength of 380 nm to 800 nm.

4. The indoor lighting fixture according to claim 1, wherein the solar cell comprises at least one selected from a Si-based photovoltaic cell, an inorganic thin-film-based photovoltaic cell of group III-V, group II-VI, and group I-III-VI, an organic photovoltaic cell, and a dye-sensitized photovoltaic cell.

5. The indoor lighting fixture according to claim 1, wherein the solar cell is an organic photovoltaic cell.

6. The indoor lighting fixture according to claim 1, wherein the electrical energy generated by the solar cell is utilized as auxiliary power for the indoor lighting fixture.

7. The indoor lighting fixture according to claim 1, wherein the drive device further comprises therein a power inverter configured to convert the electrical energy stored in the rechargeable battery into energy that is usable by the LED light.

8. The indoor lighting fixture according to claim 1, wherein:
the drive device further comprises an input module configured to receive external power; and
the power input from the input module is used to charge the rechargeable battery.

9. The indoor lighting fixture according to claim 8, wherein the input module receives external power if the electrical energy charged in the rechargeable battery is discharged to a threshold value or less.

10. The indoor lighting fixture according to claim 1, wherein the drive device further comprises therein an LED inverter configured to drive the LED light.

11. The indoor lighting fixture according to claim 1, wherein the indoor lighting fixture comprises a plurality of LED lights and a plurality of drive devices, which are connected to each other.
